(19) United States
(12) Patent Application Publication
(10) Pub. No.: US 2009/0222353 A1
(43) Pub. Date: Sep. 3, 2009

(54) Payment system

(76) Inventors: John Guest, Hants (GB); Brian Tagg, Somerset (GB)

Correspondence Address: Thomas F Bergert;WIlliams Mullen, 8270 Greensboro Drive, Suite 700, McLean, VA, 22102, US

(21) Appl. No.: 10/539,461

(22) PCT Filed: Dec. 22, 2003
(86) PCT No.: PCT/IB03/05665

§ 371 Date: Jan. 28, 2008

(30) Foreign Application Priority Data
Dec. 20, 2002 (GB) 0229765.3

(51) Int. Cl. G06Q 20/00; G06Q 10/00; G06F 17/30; G06F 17/40; H04M 11/00

(52) U.S. Cl. 705/17; 705/30; 707/3; 707/101; 705/44; 455/406; 707/E17.019; 707/E17.014

(57) ABSTRACT

The credit a mobile radio apparatus account, the display (15) of the a mobile telephone (10) is used to display an image including a barcode (1) which graphically represents transaction data. This includes data identifying a transaction database records in a transaction database (75), the transaction database records including data identifying the mobile radio apparatus account. An account database (83) comprises account database records of mobile radio apparatus accounts including an amount of credit. A retail terminal (30) provided in a retail location has a reader (40) which reads the barcode (1). The retail terminal (30) accepts payment and communicates the read transaction data and data indicating that payment has been accepted to a transaction control system remote from the retail terminal (30). The transaction database (75) is updated to indicate that payment has been accepted and the account database (83) is updated to credit the mobile radio apparatus account by the payment amount.

The present invention relates to a payment system and method allowing consumers to make payments at retail locations. It relates in particular to the use of technical means to facilitate the transaction, Whilst the invention relates specifically to payments for crediting an account for a mobile radio apparatus, such as a mobile telephone, it is also more generally applicable to payment for other products.

Mobile telephones are now a very common consumer product. In many countries, a popular type of payment arrangement for a mobile telephone is for the user to make payments to credit their account in advance of using the mobile telephone. This type of payment arrangement is commonly known as “pre-pay”. The process of making a payment and crediting the user's account is commonly known as a “top-up”, which term reflects the normal manner of usage in which the user frequently tops up their account by relatively small amounts.

Pre-pay is very popular. For example, in the United Kingdom, since the introduction of pre-pay mobile services in 1995, the market has grown rapidly to over 30 million users, each on average topping up their phone around eight times a year.

Pre-pay systems allow the user to make payments at a variety of retail outlets, thereby allowing the user to pay for a top-up at a location which is convenient to 20 them.

The original top-up system involves the purchase of a voucher which is subsequently used to credit a mobile telephone account. The voucher system involves the purchase of a voucher bearing a PIN (of up to 16 digits) at a retail outlet. It requires a telephone call to an interactive voice response (IVR) system and entry of the PIN on the mobile telephone to validate the voucher prior to crediting the account of the mobile telephone.

As the market expanded, the logistical complexity of maintaining the voucher system has led mobile network operators to seek more effective alternatives. The large number of vouchers and associated transactions has led to increased costs in managing the system, in particular to reduce the opportunities for fraud and system abuse.

More recently, electronic payment systems of crediting a mobile phone account have been developed. The first electronic payment system in the United Kingdom was introduced in 1999. This system used magnetic stripe cards in which limited user details were contained within a magnetic stripe. Such a magnetic stripe card payment system involves the distribution of cards bearing a PAN (of up to 19 digits), and requires a call to an IVR system and entry of the PAN on the mobile telephone for validation of the card. Thereafter, the magnetic stripe is read when payment is made by swiping the card through a reader in a retail outlet to identify the mobile telephone account.

Despite intense efforts by the mobile network operators to promote such an electronic payment system, there has not been a great take-up by consumers. Currently in the United Kingdom, the voucher payment system dominates, accounting for approximately 70% of all pre-pay top-up sales, which amounts to an estimated 170 million sales per year. Consumer research suggests that the failure of payment systems including magnetic stripe cards to provide an acceptable alternative to paper vouchers is due to an inherent resistance by users to initially pre-register their personal details, combined with the inconvenience of carrying a separate magnetic stripe card leading to failure to do so.

The present invention has been developed as an alternative payment system and method and involves the use of different technical means from those described above to effect payment for crediting a mobile radio apparatus account.

According to a first aspect of the present invention, there is provided a method of crediting a mobile radio apparatus account using:
a mobile radio apparatus having a radio communication circuit and a display capable of displaying an image including a graphical representation of data;
a retail system having a reader capable of reading graphically represented data displayed on said display of said mobile radio apparatus; and
a transaction control system remote from the retail system, the retail system and the transaction control system being capable of communicating over a communications link, the transaction control system storing account database records of mobile radio apparatus accounts, each account database record including an amount of credit; and
the method comprising:
displaying on the display of the mobile radio apparatus an image including a graphical representation of transaction data which includes data corresponding to an account database record;
using the reader of the retail system to read the graphically represented transaction data displayed on the display of the mobile radio apparatus;
using the retail system to accept a payment;
communicating from the retail system to the transaction control system, the read data corresponding to an account database record and data indicating that payment has been accepted;
updating the account database record corresponding to the communicated data to credit the mobile radio apparatus account by the payment amount.

According to a second aspect of the present invention, there is provided a payment system for crediting a mobile radio apparatus account comprising:
a transaction control system storing account database records of mobile radio apparatus accounts, each account database record including an amount of credit; and
a mobile radio apparatus having a radio communication circuit and a display capable of displaying an image including a graphical representation of transaction data which includes data corresponding to an account database record;
a retail system remote from the transaction control system; and
a communications link between the retail system and the transaction control system,
the retail system comprising:
a reader capable of reading graphically represented transaction data displayed on said display of said mobile radio apparatus;
payment means for accepting a payment; and
means for communicating the read data corresponding to an account database record and data indicating that payment has been accepted over the communications link to the transaction control system;
the transaction control system comprising account update means for updating the account database record corresponding to the communicated data to credit the mobile radio apparatus account by the payment amount.

To identify a desired transaction, the present invention uses the mobile radio apparatus to display an image including a graphical representation of transaction data. The transaction data corresponds to an account database record which is a record of the desired transaction stored remotely from the retail system. The image is displayed by the user to the reader of a retail system to read the graphically represented data and payment is accepted using the retail system. The data corresponding to an account database record, read as part of the transaction data, and also data indicating that payment has been accepted, is communicated from the retail system to the transaction control system. This communicated data is then used to update the account database record to credit the account by the payment amount. Thus, the image displayed on the mobile radio apparatus is used to identify the account which is to be credited. This provides for safe and reliable payments.

The payment is accepted by a retail system which may be any system capable of accepting a payment. Typically, the retail system will include a retail terminal, such as a terminal of a type currently used in retail outlets. The retail terminal may be arranged to implement the entire payment process and the communication with the transaction control system. In this case, the retail system is constituted by the reader and the retail terminal together. However, this is not essential and the various functions of the retail system may be implemented in separate units. For example, the retail system may comprise a combination of a conventional retail terminal which implements the payment process and an additional terminal which implements the communication with the transaction control system. In this case, the additional terminal may be connected to the reader. This arrangement is advantageous in that it allows the present invention to be invented by a retail terminal already provided in a retail outlet, but by adding the additional terminal and reader.

A alternatively, some of the payment processing may occur remotely from the retail terminal. For example, the retail system may comprise a retail terminal which can communicate with a host server, e.g. over a local area network. In this case, the host server may perform the payment process and the retail terminal primarily acts to control the interaction with the consumer through appropriate data input means such as a keyboard or touch screen and/or means for reading a credit card. Whatever the nature of the retail system, it includes some means for accepting payment from the consumer.

The payment may be in any form, for example by cash or by credit card. In the case of a cash transaction, where a retail terminal implements the payment processing, the means for accepting payment may be the keyboard and associated processing which allows physical receipt of cash to be confirmed by appropriate operation of keys on the keyboard. In the case of an unmanned retail terminal, the means for accepting payment may be an appropriate mechanical system, for example as used in known vending machines. In the case of payment by credit card, the means for effecting payment may be a conventional device for reading data stored on the credit card or entering the number of the credit card, and the associated processing.

Retail terminals may be provided in a large number of locations, for example, in retail outlets such as shops, or any other establishment where payment may be accepted, such as a ticket booth. Alternatively, the possibility of the retail terminal being unmanned allows retail terminals to be provided at a larger number of locations.

The reader may be provided as an integral part of the retail terminal or may be a separate unit connected to the retail terminal.

The present invention provides a payment system which provides advantages to each of the users, the retailers and the mobile network operators.

As far as users are concerned, the present invention provides the advantage of simplicity of use and understanding. There is no need to use anything other than the mobile radio apparatus itself. There is no need to purchase a voucher or to carry a magnetic stripe card. The user needs merely to visit a retail outlet or other location having a retail system, to display the image including the graphical representation of data and to make the payment. These are all routine tasks. In particular, display of the image may be achieved using existing functionality of the mobile radio apparatus. Users do not need to enter a PIN as is necessary for validation in voucher payment systems or a PAN as is necessary for validation of the magnetic stripe card of the electronic payment system. This is because the graphically represented data corresponds to an account database record.

It is therefore expected that the present invention will be readily accepted by consumers.

From the point of the retailer, the system is again simple to use and understand. The retailer simply uses a reader to read the displayed image. This requires relatively little retailer training because it is a straightforward task, similar to that routinely used to read barcodes to identify products in many shops such as supermarkets. Thereafter, the retailer need only control the retail system to accept the payment, in the same manner as for any other purchase, for example by accepting cash or a credit card payment. Indeed, the task at the retailer is so straightforward that it is possible to implement an automatic retail terminal which is operated directly by the consumer using technology similar to that in a vending machine to accept payment. Also, the retailer does not need to hold any stock as is necessary with the voucher payment system. Thus the retailer never has voucher supply problems and there is a reduced risk of fraud to the retailer.

As far as the mobile network operators are concerned, a significant advantage is that a high take-up by users and retailers is likely due to the advantages described above. In addition, the payment system is simple to implement. There is no need to manufacture and distribute vouchers or electromagnetic cards. There is no need for an IVR system for validation. It is expected that a payment system in accordance with the present invention will be cheaper to implement than the existing payment systems described above.

Also, the present invention provides a relatively flexible system which can be adapted, for example to change the payment amount or to introduce conditions on desired transactions, as will be described further below.

It is also noted that the present invention does not necessitate changes to the mobile radio apparatus, such as new or updated software or SIM changes (although these might be useful optional features). This is because the present invention uses an image which may be displayed using the existing functionality of the mobile radio apparatus to display images. As the images are read passively, there is no need for any form of active transmission of data such as infrared transmission or electromagnetic transmission, e.g. Bluetooth.

Preferably, the transaction control system further stores transaction database records of desired transactions for respective mobile radio apparatus accounts, and said data corresponding to an account database record included in said transaction data is data which identifies a transaction database record.

The use of transaction database records, in addition to account records, has the advantage that the transaction database records store information about the desired transaction. This may be used to facilitate the transaction. For example, the transaction database record might include the payment amount or conditions which might be used at the time when payment is accepted. In this case, the data included in the graphically represented transaction data displayed on the mobile radio apparatus identifies a transaction database record. It therefore corresponds to an account database record because the identified transaction database record contains information about a transaction in respect of a particular mobile radio apparatus account.

However, it is not essential to implement the present invention using a transaction database record. Instead, the data included in the graphically represented transaction data displayed on the mobile radio apparatus may directly identify an account database record.

Preferably, the transaction control system stores the account database records and the transaction database records in an account database and a transaction database, respectively, which databases are separate from each other, each transaction database record including an account number identifying an account database record in the account database, the transaction control system further comprises extraction means for extracting, from the transaction database record identified by the communicated data, the account number of a mobile radio apparatus account in the account database, and the account update means is arranged to update, in the account database, the account database record identified by the account number extracted from the transaction database.

The use of a separate account database and transaction database is advantageous, because it allows the present invention to be implemented using an existing account database of a mobile network operator, by newly introducing a transaction database. It also allows the present invention to be implemented using a single transaction database in combination with plural account databases, for example for different mobile network operators. This in turn facilitates implementation of the present invention in a common manner for different mobile networks. Lastly, the use of a separate transaction database facilitates the application of the present invention to several different products besides crediting a mobile radio apparatus account (as discussed in more detail below) using a single transaction database.

To implement the account database and transaction database separately, the databases may be provided in a separate account server and transaction server, respectively, with a communications link therebetween.

However, it is not essential to provide the transaction database and account database separately. Alternatively, the transaction database records could be provided in the same database as the account database records, for example by the transaction database records each forming part of a respective account database record in respect of a particular account.

Preferably, the image is a message received by the mobile radio apparatus. For supplying the message, the transaction control system may include transmission means for transmitting a message comprising an image including a graphical representation of transaction data which includes data corresponding to an account database record.

Supplying the image as a message takes advantage of the existing messaging functionality of the mobile radio apparatus. This allows straightforward storage of the images, because storage of received messages is an integral part of the existing messaging functionality. Thus, the present invention may be achieved without any special software on the mobile radio apparatus. It also provides for ease of use by the user.

The transmission of the graphical representation of data in a message, also allows additional content to be included in the message, together with the graphically represented data. In general, the additional content may be of any nature, including advertising material or other information addressed to the user. This conduit for additional content is of particular advantage to the mobile network operator.

The present invention may use any type of messaging for transmitting a message to a mobile radio apparatus. Currently, SMS messaging is preferred, but other types of messaging are equally possible, for example MMS, EMS or WAP.

Despite the advantages of the image being transmitted in the form of a message, this is not essential. It would alternatively be possible to transmit the transaction data to the mobile radio apparatus in a data format, from which the mobile radio apparatus would generate the graphical representation. This would, however, require appropriate software to be provided on the mobile radio apparatus.

Preferably, the messaging means further includes reception means for receiving a request message from the mobile radio apparatus indicative of the desire to credit the mobile radio apparatus account of the mobile radio apparatus, the transaction control system further includes transaction database record creation means, respective to the receipt of a message by said reception means, for creating a transaction database record including the data identifying the account of the mobile radio apparatus from which a message is received, and said transmission means is responsive to the creation of a transaction database record by said transaction database record creation means for transmitting a message comprising an image including a graphical representation of transaction data which includes data identifying the created transaction database record.

In this way, both the transaction database record and the message including the graphical representation transaction data are created in response to a request message from the mobile radio apparatus.

This technique also allows accurate recording of the correct telephone number, or other data identifying the account, for the desired transaction in the transaction database record, because the mobile radio apparatus may be identified directly from the request message.

The request message also provides the advantage of providing a simple mechanism by which the user can register the desire to credit the account simply by sending a request message to a predetermined number.

One possibility is for the request message to be blank so that mere receipt of a message at a predetermined telephone number indicates the desire to credit the account. In this case, different telephone numbers might be used to designate different payment amounts, or the payment amount might not be specified at all. Another possibility is for the text message to include simple text identifying the desired payment amount.

However, the use of such a request message is not essential. A request could be made by any other means, for example a voice call. Alternatively, messages input to the graphical representation of data could be transmitted to mobile radio addresses in an unsolicited manner.

There are several ways for the retail system to identify the payment amount, as follows:

A first option for identifying the payment amount is that the transaction data further includes the payment amount and the payment means is arranged to accept the principle of the payment amount read as part of the transaction data. This option is advantageous in that it avoids the need to obtain the desired payment amount from the transaction database record. It therefore speeds up the payment process.

A second option for determining the payment amount is that each transaction database record includes the payment amount, the transaction control system includes retrieval means, responsive to the data identifying a transaction database record communicated from the retail system, for retrieving the payment amount from the transaction database record identified by the communicated data and communicating the retrieved payment amount to the retail system, and the payment means is arranged to accept the payment of the payment amount communicated from the transaction control system.

This option has the advantage of the payment amount being automatic and accurately supplied to the retail system from the relevant transaction database record.

A third option is for the user to specify the payment amount. In this case, the retail system has input means for inputting the payment amount during the payment processing. Similarly, this third option could be applied to change the payment amount identified using the first or second options. If the payment amount is specified by the user, then it is communicated from the retail system to the transaction control system in a similar manner to the data identifying a transaction database record and the data indicating that payment has been accepted.

Advantageously, the transaction control system includes authorization means, responsive to the data identifying a transaction database record communicated from the retail system, for checking the transaction database record identified by the communicated data and communicating an authorization to the retail system if a predetermined criterion is met, and the payment means is arranged to inhibit payment until receipt of the authorization by the retail system.

Inclusion of such an authorization process is advantageous because it allows the transaction to be controlled by the transaction control system. A wide variety of predetermined criterion may be used, from a simple check that a proper transaction database record is identified to checking whether conditions specified in the transaction database record are met. Numerous conditions are possible. For example, the conditions might specify a particular time period outside which the authorization is not to be provided to enable the transaction database records to “expire” at a certain date.

Thus, it can be seen that such an authorization process can provide a wide, flexible rate of additional functions which can reduce both errors and fraud, and/or can provide additional functionality to the payment system.

The present invention is particularly applicable to a mobile radio apparatus in the form of a mobile telephone, but may equally be applied to any other form of mobile radio apparatus, for example a portable digital assistant or indeed any apparatus capable of radio communication over a mobile network.

Preferably, the graphical representation is a two-dimensional barcode. Two-dimensional barcodes are conventional in themselves. Their use with the present invention allows known technology to be applied to form and read the graphically representation of the transaction data. The use of a two-dimensional barcode also provides the advantage of being able to represent large amounts of information in a restricted area.

Any format for the two-dimensional barcode may be applied. Preferably the barcode format is QR Code, but other possible formats include PDF417, Code 16K, Code 4D Digital Matrix, Maxicode, Code One or Aztec Code. Although a stacked two-dimensional barcode may be used, preferably a matrix two-dimensional barcode is used because of the inherent advantages of increasing the amount of data stored. The ability to store large amounts of data also provides the advantage that the barcodes may incorporate error correction capability to allow recovery from data corruption, as well as often decoding algorithms, for example to enhance security.

Optionally, the graphically represented data may be encrypted.

While two-dimensional barcodes are preferred, the graphical representation of data may be in any other format which allows the data to be read by a reader at the retail system. This includes one-dimensional barcode or, representation of the data by other format to be read by a reader incorporating an optical character recognition system.

The present invention is described above as a payment system and method for crediting an account of a mobile radio apparatus. However, the present invention may equally be applied to payment for products other than the crediting of an account for a mobile telephone apparatus. Indeed, the present invention may be applied to payment for many products, including tangible products such as goods, including ticketing, and intangible products such as services.

Thus, in accordance with a third aspect of the present invention there is provided a method of payment for a product using:
a mobile radio apparatus having a radio communication circuit and a display capable of displaying an image including a graphical representation of data;
a retail system having a reader capable of reading graphically represented data displayed on the display of said mobile radio apparatus; and
a transaction control system remote from the retail system, the retail system and the transaction control system being capable of communicating over a communications link, the transaction control system storing transaction database records of desired transactions each including data identifying a desired product,
the method comprising:
displaying on the display of the mobile radio apparatus an image including a graphical representation of transaction data which includes data identifying a transaction database record;
using the reader of the retail system to read the graphically represented transaction data displayed on the display of the mobile radio apparatus;
using the retail system to accept a payment;
communicating from the retail system to the transaction control system, the read data identifying a transaction database record and data indicating that payment has been accepted;
updating the transaction database record identified by the communicated data to indicate that payment has been accepted; and
delivering the product identified in the identified transaction database record.

According to a fourth aspect of the present invention, there is provided a payment system comprising:
a transaction control system storing transaction database records of desired transactions each including data identifying a desired product;
a mobile radio apparatus having a radio communication circuit and a display capable of displaying an image including a graphical representation of transaction data which includes data identifying a transaction database record;
a retail system remote from the transaction control system; and
a communications link between the retail system and the transaction control system,
the retail system comprising:
a reader capable of reading graphically represented transaction data displayed on the display of the mobile radio apparatus;
payment means for accepting a payment; and
means for communicating the read data identifying a transaction database record and data indicating that payment has been accepted over the communications link to the transaction control system;
the transaction control system comprising:
   means, responsive to the data communicated from the retail system, for updating the transaction database record identified by the communicated data to indicate that payment has been accepted.

Similarly, the various features of the present invention as applied to crediting an account for a mobile radio apparatus may be generalized to any other products as follows. Instead of maintaining and updating account database records, appropriate means for delivering the product in question are provided. The manner of delivery will depend on the product in question, but includes generating an order for a supplier to supply a product, communication of data to instruct a service provider to provide a service or where a product is intangible and represented by database records, updating that database record.

When applied to payments for products in general, the present invention provides the same advantages as described above with reference to crediting an account for a mobile radio apparatus. The present invention is particularly useful in that it provides a mechanism for allowing a consumer to pay for a product at any of a large number of retail locations, but without the retailer needing to be involved in the delivery of the product.

To allow better understanding, an embodiment of the present invention will now be described by way of non-limitative example with reference to the accompanying drawings, in which:

FIG. 1 is a two-dimensional barcode which constitutes graphically represented data;

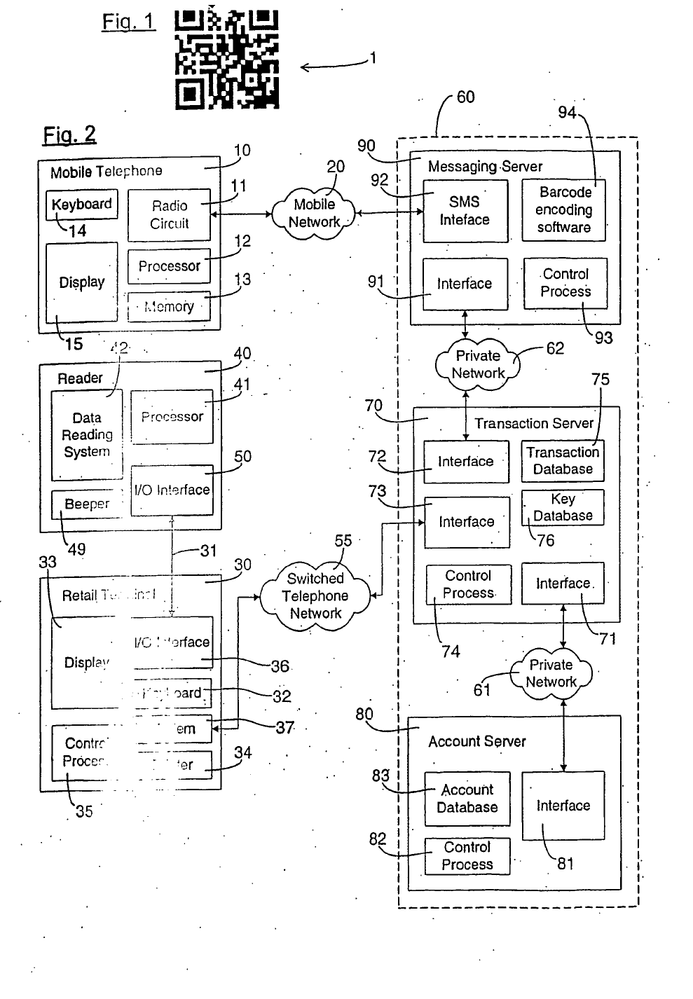

FIG. 2 is a schematic diagram of the payment system which embodies the present invention;

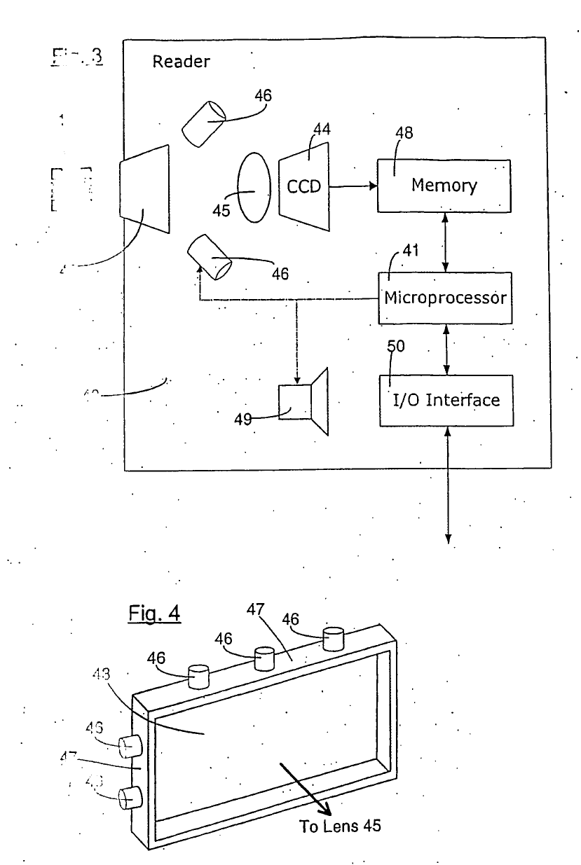

FIG. 3 is a schematic view of a barcode reader; and

FIG. 4 is a perspective view of an illumination unit of the barcode reader of FIG. 3 viewed from inside the reader.

A payment system which embodies the present invention is described below.

In the payment system, the graphical representation of data is a two-dimensional barcode, in particular a matrix barcode in the format known as QR Code. FIG. 1 illustrates an example of such a QR code barcode 1. QR Code is defined in ISO/IEC 18004. QR Code has the advantage of providing an error correction capability to allow recovery from data corruption during the reading process. QR Code is capable of representing large amounts of data with a high data density. QR Code also includes the provision of position detection patterns on three corners which allows omni-directional reading.

Handling of the QR Code barcode 1 may be performed using known techniques in accordance with the QR Code format. The payment system uses a known encoding algorithm for encoding a data string into a QR Code barcode 1 graphically representing that data string. Similarly, the present invention uses known technology for reading the barcode. As will be described in more detail below, this involves detecting an image of the barcode, and decoding the image data using a known decoding algorithm for QR Code to obtain the graphically represented data.

The payment system is illustrated schematically in FIG. 2. In particular, FIG. 2 shows the elements of the payment system, including various functional blocks included therein.

The payment system includes a mobile radio apparatus in the form of a mobile telephone 10. The mobile telephone 10 is of known construction. It includes a radio communication circuit 11 for providing communication with a mobile network 20 which is also of known form. In particular, the mobile network 20 consists of a number of distributed base stations which may be interconnected by land-lines, which ultimately interface to other switched networks such as the Public Switched Telephone Network (PSTN). The radio communication circuit 11 communicates with a local base station to provide radio communication between mobile telephone 10 and the mobile network 20. The mobile network 20 may be one of the existing mobile networks, for example in the case of the United Kingdom those currently operated by Vodafone, Orange, T-mobile or 0₂. Of course the payment system may include many mobile telephones 10, which may operate over different mobile networks 20.

The mobile telephone 10 also comprises a microprocessor 12, a memory 13, a keyboard 14 which acts as an input means for the user, and a display 15.

The microprocessor 12 runs software to control operation of the mobile telephone 10, providing a variety of functions. One of the functions is to receive and handle messages, in an SMS format or any other messaging format. SMS stands for Signal Message Service. SMS messaging currently allows messages of up to 160 alpha numeric and punctuation characters to be sent quickly and cheaply between mobile telephones. The messages may include images. The messages are received over the mobile network 20 using the radio communication circuit 11, and are stored in the memory 13. Using the keyboard 14 to input commands, the stored messages may be selected and displayed on the display 15.

As will be described in more detail below, the payment system relies on the mobile telephone 10 receiving a message including an image which includes a barcode which graphically represents transaction data. The existing functionality of the mobile telephone 10 allows the user to display the message including the barcode in display 15.

The payment system further includes multiple retail terminals 30, one of which is shown in FIG. 2. The retail terminals 30 are provided in retail locations such as shops. Each retail terminal 30 has a reader 40 which is capable of reading the barcode 1, that is to read the transaction data graphically represented by the barcode 1. The retail terminal 30 and the reader 40 together constitute a retail system.

The retail terminal 30 and the reader 40 are linked together for communication by a cable 31. The reader 40 has an input/output interface 50 for communicating data to the retail terminal 30 and for accepting commands from the retail terminal 30 for control of a reader 40. The reader 40 operates under the control of a microprocessor 41 running the appropriate software.

The reader 40 further includes a data reading system 42 which will now be described in more detail with reference to FIGS. 3 and 4.

FIG. 3 schematically illustrates the components of the data reading system 42 which are as follows.

A window 43 is provided in the housing (not shown) of the reader 40. A charge coupled device (CCD) 44 is disposed inside the window 43 with a lens 45 and used to focus images of objects spaced adjacent to the window 43 onto the CCD 44. The CCD 44 captures an image of the object. In use, the display 15 of the mobile telephone 10, with the barcode 1 displayed thereon, is placed adjacent the window 43 so that the CCD 44 captures an image of the barcode 1.

In addition, the data reading system 42 includes an illumination unit for illuminating an object placed adjacent the window 43 as illustrated in FIG. 4. The illumination unit comprises a plurality of light emitting diodes (LEDs) 46 which are arranged as illustrated in perspective view in FIG. 4. The LEDs 46 are arranged to provide indirect illumination. This is achieved by arranging the LEDs 46 around the perimeter of the window 43. To provide shadow-less illumination, the LEDs 46 direct in towards the window 43 through a screen 47 arranged to diffuse the light emitted by the LEDs 46. The screen 47 may be formed of any suitable diffusive material, for example a frosted plastic. The illumination unit consisting of the LEDs 46 and the screen is particularly advantageous for reading a barcode 1 displayed on the display 15 of the mobile telephone 10, because the image will typically be of very low contrast, particularly if the display 15 is not illuminated.

Optionally, the LEDs 46 may be switched on and off, under the control of the microprocessor 41, to indicate when the reader 40 is ready for use.

The data reading system 42 further includes a memory 48 to which the contents of the CCD 44 are periodically transferred, typically at around 25 Hz. The microprocessor 41 runs conventional software to recognise when an image of the barcode 1 is stored in the memory 48 by recognising identifying characteristics of a QR code barcode. Upon such recognition, the software uses a known decoding algorithm, as described above, to obtain the transaction data graphically represented by the barcode 1. The decoding algorithm may incorporate error correction. On system reading of the transaction data, the software causes sounding of a beeper provided in the reader 40. If no barcode is recognized, then the next image captured by the CCD 44 is loaded into the memory 48 and the process repeats.

The reader 40 communicates the read transaction data to the retail terminal 30 used as the input/output interface 50. Once the transaction data has been successfully repeated the software causes the microprocessor 41 to examine successive images loaded into the memory 48 to determine when the barcode 1 has been moved away. At that point, the telephone 10 repeats the process to read a further barcode 1.

The retail terminal 30 is of a conventional type for processing payment in a retail situation. It includes a keyboard 32 as an input means for operating the retail terminal 30. It also includes a display 33, such as an LCD display, used to display information during the payment process, for example the payment amount and the name of the product. The retail terminal 30 further includes a printer 34 which may be used to print receipts.

The retail terminal 30 is controlled by a control process 35 which may be then printed by software running on a microprocessor. The control process 35 causes the retail terminal 30 to operate in a manner which will be described in more detail below.

The control process 35 includes payment processes for accepting payments, for example cash payments or electronic payments, e.g. by credit card. For accepting payments by cash, the payment processing includes a step of data entry through the keyboard 32 to confirm physical receipt of the cash. For accepting payments by credit card, the retail terminal 30 may include a credit card reader (not shown) for reading the credit card details and the payment processing includes steps of communicating with the credit card provider. Such payment processes are in themselves conventional, but the control process 35 includes further steps specific to implementing the invention, as described in more detail below.

The retail terminal 30 further includes an input/output interface 36 provided for communication with the reader 40 over the cable 31. In particular, the input/output interface 36 allows the retail terminal 30 to receive transaction data from the reader 40 and to issue commands to control the reader 40.

The retail terminal 30 also includes a modem 37 allowing the retail terminal 30 to communicate over a switched telephone network 55 which may be the PSTN or any other switched network. The switched telephone network 55 is used as a communications link between the retail terminal 30 and a transaction control system as described in more detail below. In principle, the switched telephone network 55 could be replaced by any other communications link, but the switched telephone network 55 is preferred for ease of implementation, in particular because it is allowed using communications with a large number of existing retail locations without necessitating additional infrastructure.

The payment system further comprises a transaction control system 60 consisting of a transaction server 70, an account server 80 and a messaging server 90. Each of the servers 70, 80 and 90 are arranged in different locations. The transaction server 70 and the account server 80 communicate over a first private network 61. The transaction server, 70 and the SMS server 90 communicate over the second private network 62. The first and second private network 61 and 62 may be a network of any suitable form allowing communication between the servers 70, 80 and 90. They will typically be networks providing a high degree of security. The first and second private networks 61 and 62 may be constituted by the same or different networks. In principle, the first and second private networks 61 and 62 could be replaced by any form of communication link allowing communication between the servers 70, 80 and 90.

Each of the servers 70,80 and 90 is a computer system of conventional construction. The servers 70, 80 and 90 run software to implement the present invention as described in more detail below. Whilst the use of a separate transaction server 70, account server 80 and messaging server 90 is preferred, alternatively the functionality of any of the servers 70, 80 and 90 may be combined in the same server.

The servers 60, 70 and 80 store various databases consisting of database records which include a key used to locate database records within the database in a 10 conventional manner.

The transaction server 70 is arranged as follows.

The transaction server 70 has first and second interfaces 71 and 72 for communicating with the accounts server 80 and the messaging server 90, respectively, over the first and second private networks 61 and 62, respectively. In addition, the transaction server 70 includes a third interface 73 for communication which the retail terminal 30 over the switched telephone network 55. The transaction server 70 has a control process 74 which may be implemented by a processor running appropriate software. The control process 74 controls the operation of the transaction server 70 to implement the present invention as described in more detail below. The control of the control process 74, the transaction server 70 maintains a transaction database 75 and a key database 76.

The transaction database 75 stores records of desired transactions for respective mobile radio apparatus accounts. In particular, the transaction database records each comprise:
data identifying a particular mobile network operator;
the telephone number of a particular mobile telephone 10; and
the desired payment amount.

The mobile telephone number is used as the key for the transaction database records of the transaction database 75. As described in more detail below, the telephone number stored as part of the transaction database record is used as data to identify the account of the mobile telephone 10.

The records of the key database 76 consist of mobile telephone numbers which are used as the keys to the transaction database 75. The keys for the key database 76 are randomly generated numbers.

In use, the randomly generated keys are included in the transaction data represented by the barcodes in the mobile telephone 10. As the records of the key database 76 are mobile telephone numbers which correspond to a mobile telephone account, the keys for the key database 76 similarly correspond to a mobile telephone account. As described in more detail below, the keys for the key database 76 are used to identify a transaction database record in the transaction database 75 which in turn are used to identify a mobile telephone account. A particular transaction database record in the transaction database 75 is located using the key database 76 to link the randomly generated key in the transaction data to a particular transaction database record.

The account server 80 is the existing account of a particular network operator. The payment system may include plural account servers 80 of different network operators. The account server 80 is arranged as follows.

The account server 80 has an interface 81 for communicating with the transaction server 70 over the first private network 61.

The account server 80 has a control process 82 which may be implemented by a processor running appropriate software. The control process 82 controls the operation of the account server 80 to implement the present invention as described in more detail below.

The account server 80 stores an account database 83 consisting of account database records which are each a record of information concerning a respective mobile telephone account. The account database records include various information about the account, including an amount of credit. As the mobile telephone 10 is used, the amount of credit in the account database record for the account in respect of that mobile telephone 10 is reduced. Typically, the account database records will include much other information as well, for example information about the user and the type of account. The mobile telephone number may be used as a key to the account database records in the account database 83.

The messaging server 90 is arranged as follows.

The messaging server 90 has an interface 91 for communicating with the transaction server 70 over the second private network 62.

The messaging server 90 further includes a SMS messaging interface 92 for sending and receiving SMS messages over the mobile network 20. In use, the SMS messaging interface 92 is used to send message to, and receive messages from, the mobile telephone 10. In particular, the SMS messaging interface 92 has one or more telephone numbers to which the mobile telephone 10 can send messages. In the event that the payment system is applied to plural mobile networks 20, there may be a separate messaging interface 92 for each mobile network 20.

The messaging server 90 has a control process 93 which may be implemented by a program or running appropriate software. The control process 93 controls the account of the messaging server 90 to implement the present invention as described in more detail below.

The messaging server 90 further includes encoding software 94 for encoding data to a QR Code barcode 1.

Operation of the payment system will now be described. The operation is controlled by the control process 35, the control process 74, the control process 82 and the control process 93 of the retail terminal 30, the transaction server 70, the account server 80 and the messaging server 90, respectively. In this manner, the control processes 35, 74, 82 and 93 constitute means for forming various functions corresponding to the various codes as defined in the claims.

The first stage is a registration. This is initiated by the user sending a request made from the mobile telephone 10 to the messaging server 90 to indicate the desire to credit an account of the mobile telephone 10.

The request message may be prepared using the messaging functionality of the mobile telephone 10. The request message is sent to a telephone number of the messaging server 90. The user might be informed of the appropriate telephone number of the messaging server 90 in advance, for example as part of a mail-shot or by automated SMS message.

The content of the SMS message may also indicate the nature of the desired product, that is indicating crediting of a mobile telephone account, and also the desired payment amount. For example, the message format might be “topup10” to indicate a payment by £10. As an alternative, a different telephone number might indicate different dedicated payment amounts, in which case the message might include no content at all.

On receipt of the request message, the messaging server 90 assembles the 10 following information:
the desired payment amount, as included in the text of the request message, or alternatively as indicated by the telephone number to which the request message is sent;
the network operator of the mobile network 20, of the mobile telephone 10, which is given from the identity of the mobile network 20 from which the request message is requested: and
the telephone number of the mobile telephone 10 which is also known from the additional information accompanying the request message, for example the MSISDN from the transmission record containing the request message.

In the event that the content of the request message cannot be successfully parsed, then the messaging server 90 replies to the request message with a message explaining the problem and suggesting ways of avoiding similar errors in the future.

The assembled data is then transmitted from the messaging server 90 to the transaction server 70.

The transaction server 70 creates a transaction database record using the data transferred from the messaging server 90. The transaction database record includes all the transmitted from the messaging server. The telephone number of the mobile telephone 10 is used as a key to the created transaction database record. In addition, a key of those record is created in the key database 76. The key database record comprises the mobile telephone number of the mobile telephone 10. A number is randomly generated using a pseudo-random number generator. The randomly generated number is changed to be unique against the keys already stored as keys in the key database 76. Provided it is unique, the randomly generated number is stored as the key to the newly created key database record. If it is not unique, a new random number is generated and the seeking process is repeated.

The transaction server 70 then assembles the key and a product code, which is identifying the product, that is the network operator of the mobile network 20 and a desired payment amount. The product code is extracted from a table stored on the transaction server 70 containing product codes for all possible combinations of mobile operators and payment amounts. Later, the product code is used to identify both the mobile network operator and the payment amount at the retail terminal 30. The key to activated key database record in the key database 76 is later used as data to identify the desired transaction database record in the transaction database 75 because it used to acquire the telephone number in the record of the key database 76 which in turn is used to access the transaction database. Furthermore, the key to the created key database record in the key database 76 corresponds to an account database record, belonging to the transaction database record in the transaction database 75 identified thereby in the mobile telephone number of a particular mobile telephone 10 which may be used accordingly to identify an account database record in the account database 83. The key and the product code, which are both numeric, constitute transaction data in the following way. The transaction data is transmitted back to the messaging server 90.

On receipt of the transaction data, the messaging server 90 uses the encoding server 94 to generate a barcode 1 which is a graphical representation of the transaction database messaging server 90 then constructs a message including the barcode 1. The message may also include further content such as information for the user or a messaging material. The messaging server 90 then transmits the message to the mobile telephone 10 over the mobile network 20.

On receipt of the message, the user may view the message on the display 15 and store it in the memory 13 using the keyboard 14 to control the messaging functionality of the mobile telephone 10.

At a time of the user's choosing, the user visits a location having a retail terminal 30 equipped with a reader 40 to pay for a top-up. The keyboard 32 of the retail terminal 30 is operated by the retailer to perform the process for a barcode-activated terminal. This causes the retail terminal 30 to send a command to the reader 40 to commence reading.

The user operates the mobile telephone 10 to display the received message including the barcode 1 on the display 15, and then positions the mobile telephone 10 with the displayed barcode 1 adjacent the window 43 of the reader 40.

The reader 40 reads the transaction data represented by the barcode 1, in the manner described above, and transmits the transaction data to the retail terminal 30.

The retail terminal 30 extracts the product code from the transaction data and uses it to determine the payment amount and the mobile network operator by referring to a table stored in the retail terminal 30 identical to tire table used by the transaction server 70 to generate the product code. The retail terminal 30 then displays the information on the display 33 for checking with the user.

At this point, there is an optional authorization stage. The authorization stage starts with the retail terminal 30 transmitting the key of the key data base 76, which is retail part of the transaction data, to the transaction server 70. Next, the transaction server 70 uses the received key to check the transaction database record in the transaction database 75 identified by the key, using tire key database 76. The transaction server 70 determines whether a predetermined criteria is met. Various criteria are possible. Indeed the ability to select different criteria provides the authorisation step with significant formality.

A simple criteria is simply to check that a corresponding transaction database really actually exists in the transaction database 75.

A more complicated criteria is to check the transaction database record correlates with the product code read by the reader 40 as part of the transaction data. This of course requires that the retail terminal 30 additionally communicates the product code to the transaction servers 70.

Other possible criteria include checking conditions represented by data in the transaction database record. For example, the transaction database record might specify a time period outside which authorization is not given or a deadline after which authorization is not given. This allows the transaction database record to expire after a certain time. It is envisaged that any other types of condition might be implemented.

If the predetermined criteria is met, the transaction server 70 communicates an authorization to the retail terminal 30. The retail terminal 30 is inhibited from accepting the payment unless the authorization is received.

The next step is for the retail terminal 30 to accept the payment. In itself, the payment process is a conventional process for receiving a payment, for example by cash or by credit card.

The payment amount is displayed on the display 33 of the retail terminal 30. There are several options to identify the payment amount for the payment process.

A first option is that the payment amount is identified from the product code retail part of the transaction data.

A second option is for the payment amount to be retrieved from the transaction database 75 of the transaction server 70. To achieve this, the key of the key database 76 is transmitted from the retail terminal 30 to the transaction server 70 which is then transmitted key to retrieve the payment amount from the corresponding transaction database record using the key database 76. The retrieved payment amount is then transmitted back from the transaction server 70 to the retail terminal 30.

A third option is for the payment amount to be input to the retail terminal 30 using the keyboard 32, at the time of making the payment. This option may be used in place of the first or second options, or may be used to change the payment amount identified by using the first or second option.

A modification of the third option is for the transaction data to identify one of a plurality of menus stored on the retail terminal 30. The menus each include a 30 database set of possible payment amounts. The menu identified by the transaction data is displayed on the display 33 and one of the displayed amounts is selected by operation of the keyboard 32 to input the payment amount. Such menus may be periodically down loaded from the transaction server 70 to the retail terminal 30.

Once the payment process is completed, the retail terminal 30 sends data to the transaction server 70 confirming that the payment has been accepted, as well as the transaction data read by die reader, including both the product code and the key of the key database 76.

On receipt of this data, the transaction server 70 updates the transaction database record in the transaction server, 70 identified by the key to indicate that payment has been accepted. The transaction server 70 also accesses the transaction database record in the transaction database 75 using the key and assembles the following data:
the network operator;
the telephone number of the mobile telephone 10; and
any other additional information required by the account server 80, this depending on the interface specifications of the account server 80.

The assembled data is transmitted from the transaction server 70 to the account server 80.

On receipt of this data, the account server 80 updates the account database received, the account database 83 identified by the mobile telephone number received from the transaction server 70. In particular, the account server 80 credits the account by the payment amount identified in the data from the transaction server 70. On successful updating of the account database 83, die account server 80 transmits a condition record back to the transaction server 70 to confirm updating of the account database 83, and additional information such as the new balance of the mobile telephone account. Alternatively, if the update of the account database 83 is unsuccessful, then the account server 80 transmits a failure record to the transaction server 70 indicating the failure.

On receipt of a confirmation record from the account server 80, the transaction server 70 creates two records, firstly a confirmation record for the messaging server 90 containing the mobile telephone number and the new balance, and secondly a conformation record for the retail terminal 30 with the new balance. These records are then sent to the messaging server 90 and the retail terminal 30, respectively.

On receipt of a confirmation record, the retail terminal 30 displays information on the display 33 to indicate the new balance and causes the printer 34 to print receipts, for example a copy for the user and a copy for the retailer.

On receipt of the record confirmation, the messaging server 90 constructs a message containing the new balance, and sends this message to the mobile telephone 10 over the mobile network 20. This message therefore confirms to the user that the account has been properly credited.

In the event of the transaction server 70 receiving a message from the account server 80 to indicate that the updating of the account database was unsuccessful, then the transaction server 70 creates two failure records, to indicate this failure, firstly for the messaging server 90 and secondly for the retail terminal 30. The failure records are then sent to the messaging server 90 and the retail terminal 30, respectively.

On receipt of a failure record, the retail terminal 30 undergoes a process to cancel the payment process and refund the payment.

The messaging server 90, on receipt of a failure record indicating a failed top-up the messaging server 90 constructs an appropriate message and sends this to the mobile telephone 10 over the mobile network 20.

It will be appreciated that the payment system described above is merely one way of implementing the invention and numerous modifications to the hardware and software are possible.

1-38. (canceled)

39. A method of crediting a mobile radio apparatus account using:
a mobile radio apparatus having a radio communication circuit and a display capable of displaying an image including a graphical representation of data;
a retail system having a reader capable of reading graphically represented data displayed on said display of said mobile radio apparatus; and
a transaction control system remote from said retail system, said retail system and said transaction control system being capable of communicating over a communications link, said transaction control system storing account database records of mobile radio apparatus accounts, each of said account database records including an amount of credit, the method comprising the steps of:
displaying on said display of said mobile radio apparatus an image including a graphical representation of transaction data which includes data corresponding to at least one of said account database records;
using said reader of said retail system to read said graphically represented transaction data displayed on said display of said mobile radio apparatus;
using said retail system to accept payment in a payment amount;
communicating from said retail system to said transaction control system, the read data corresponding to said at least one of said account database records and data indicating that payment has been accepted; and
updating said account database record corresponding to the communicated data to credit said mobile radio apparatus account by said payment amount.

40. A method according to claim 39, wherein
said transaction control system further stores transaction database records of desired transactions for respective mobile radio apparatus accounts, and
said data corresponding to said at least one of said account database records included in said transaction data is data which identifies a transaction database record.

41. A method according to claim 40, wherein
said account database records and said transaction database records are stored in an account database and a transaction database, respectively, which databases are separate from each other, each of said transaction database records including data identifying an account database record in the account database,
said step of updating said account database record comprises:
extracting, from said transaction database record identified by said communicated data, data identifying an account database record in said account database; and
updating said account database record in the account database identified by said data extracted from the transaction database to credit said mobile radio apparatus account by said payment amount.

42. A payment system for crediting a mobile radio apparatus account comprising:
a transaction control system storing account database records of mobile radio apparatus accounts, each of said account database records including an amount of credit; and
a mobile radio apparatus having a radio communication circuit and a display capable of displaying an image including a graphical representation of transaction data which includes data corresponding to an account database record;
a retail system remote from said transaction control system; and
a communications link between said retail system and said transaction control system,
said retail system comprising:
a reader capable of reading graphically represented transaction data displayed on said display of said mobile radio apparatus;
payment means for accepting a payment in an amount; and
means for communicating the read data corresponding to an account database record and data indicating that payment has been accepted over said communications link to said transaction control system;
said transaction control system further comprising account update means for updating the account database record corresponding to the communicated data to credit said mobile radio apparatus account by said payment amount.

43. A payment system according to claim 42, wherein
said transaction control system further stores transaction database records of desired transactions for respective mobile radio apparatus accounts, and
said data corresponding to an account database record included in said transaction data is data which identifies a transaction database record.

44. A payment system according to claim 43, wherein said transaction control system further comprises transaction update means, responsive to the data communicated from said retail system, for updating the transaction database record identified by the communicated data to indicate that payment has been accepted.

45. A payment system according to claim 43, wherein
said transaction control system stores said account database records and said transaction database records in an account database and a transaction database, respectively, which databases are separate from each other, each transaction database record including data identifying an account database record in said account database,
said transaction control system further comprises extraction means for extracting, from the transaction database record identified by the communicated data, the data identifying an account database record in said account database, and
said account update means is arranged to update, in said account database, the account database record identified by the data extracted from said transaction database.

46. A payment system according to claim 45, wherein said transaction control system includes:
an account server including said account database and said account update means;
a transaction server including said transaction database and said extraction means; and
a communications link between said transaction server and said account server.

47. A payment system according to claim 43, wherein
said transaction control system includes authorisation means, responsive to the data identifying a transaction database record communicated from said retail system, for checking the transaction database record identified by the communicated data and communicating an authorisation to said retail system if a predetermined criterion is met, and
the payment means is arranged to inhibit acceptance of said payment until receipt of said authorisation by said retail system.

48. A payment system according to claim 43, wherein
each transaction database record includes said payment amount,
said transaction control system includes retrieval means, responsive to the data identifying a transaction database record communicated from said retail system, for retrieving said payment amount from the transaction database record identified by the communicated data and communicating the retrieved payment amount to said retail system, and
said payment means is arranged to accept said payment of the payment amount communicated from said transaction control system.

49. A payment system according to claim 42, wherein
said transaction data further includes the payment amount and said payment means is arranged to accept the payment of the payment amount read as part of the transaction data.

50. A payment system according to claim 42, wherein
the image is a message received by said mobile radio apparatus, and
the transaction control system includes messaging means including transmission means for transmitting a message comprising an image including a graphical representation of transaction data which includes data corresponding to an account database record.

51. A payment system according to claim 50, wherein
said transaction control system further stores transaction database records of desired transactions for respective mobile radio apparatus accounts,
said data corresponding to an account database record included in said transaction data is data which identifies a transaction database record,
said messaging means further includes reception means for receiving a request message from said mobile radio apparatus indicative of the desire to credit the mobile radio apparatus account of said mobile radio apparatus,
the transaction control system further includes transaction database record creation means, responsive to the receipt of a message by said reception means, for creating a transaction database record including the data identifying the account of said mobile radio apparatus from which a message is received, and
said transmission means is responsive to the creation of a transaction database record by said transaction database record creation means for transmitting a message comprising an image including a graphical representation of transaction data which includes data identifying the created transaction database record.

52. A payment system according to claim 50, wherein the transaction control system includes:
a transaction server including said transaction database and said transaction update means;
a messaging server constituting said messaging means; and
a communications link between said transaction server, and said messaging server.

53. A payment system according to claim 42, wherein said data corresponding to an account database record, included in said transaction data, consists of a randomly generated number.

54. A payment system according to claim 42, wherein said graphical representation is a two-dimensional matrix barcode.

55. A retail system for use in a payment system for crediting a mobile radio apparatus account, said payment system having a transaction control system storing account database records of mobile radio apparatus accounts, each account database record including an amount of credit, the retail system comprising;
a reader capable of reading graphically represented transaction data including data corresponding to an account database record displayed on a display of a mobile radio apparatus;
payment means for accepting a payment in an amount; and
means for communicating the read data and data indicating that payment has been accepted over a communications link to said transaction control system.

56. A retail system according to claim 55, wherein said payment means is arranged to accept the payment of a payment amount read as part of said transaction data.

57. A retail system according to claim 55, wherein said payment means is arranged to inhibit acceptance of said payment until receipt of an authorisation by said retail system.

58. A transaction control system for use in a payment system for crediting a mobile radio apparatus account, comprising:
an account database storing at least one account database record corresponding to a mobile radio apparatus account, said account database record including an amount of credit;
a transaction database storing at least one transaction database record corresponding to a mobile radio apparatus account, said transaction database record including at least one desired transaction;
means for receiving a communication to credit said mobile radio apparatus account by a payment amount, said communication identifying a transaction database record;
account update means for updating said at least one account database record corresponding to said transaction database record identified by said communication to credit the mobile radio apparatus account by the payment amount.

59. A transaction control system according to claim 58, further comprising transaction update means, responsive to the data communicated from a retail system, for updating said at least one transaction database record identified by the retail system communicated data to indicate that payment has been accepted.

60. A transaction control system according to claim 58, wherein said account database and said transaction database are separately maintained, wherein each of said at least one transaction database records includes data identifying an account database record in the account database, and wherein the transaction control system further comprises:
extraction means for extracting, from said transaction database record identified by said communication, the data identifying an account database record in the account database, said account update means updating, in said account database, said account database record identified by the data extracted from said transaction database record.

61. A transaction control system according to claim 58, wherein each transaction database record includes the payment amount, and further comprising retrieval means, responsive to the data identifying a transaction database record communicated from a retail system, for retrieving the payment amount from the transaction database record identified by the communicated data and communicating the retrieved payment amount to said retail system.

62. A transaction control system according to claim 58, further including authorisation means, responsive to the data identifying a transaction database record communicated from a retail system, for checking the transaction database record identified by the communicated data and communicating an authorisation to the retail system if a predetermined criterion is met.

63. A transaction control system according to claim 58, further including messaging means having transmission means for transmitting a message comprising an image including a graphical representation of transaction data which includes data identifying a transaction database record.

64. A transaction control system according to claim 63, wherein
said messaging means further includes reception means for receiving a request message from a mobile radio apparatus indicative of the desire to credit a mobile radio apparatus account of said mobile radio apparatus,
said transaction control system further includes transaction database record creation means, responsive to the receipt of a message by said reception means, for creating a transaction database record including data identifying the account of the mobile radio apparatus from which a message is received, and
said transmission means is responsive to the creation of a transaction database record by said transaction database record creation means for transmitting a message comprising an image including a graphical representation of transaction data which includes data identifying the created transaction database record.

65. A transaction control system according to claim 63, wherein the transaction control system includes:
a transaction server including said transaction database and said transaction update means;
a messaging server constituting said messaging means; and
a communications link between said transaction server and said messaging server.

66. A transaction server for use in a payment system, comprising
a transaction database of transaction database records of desired transactions, each transaction database record including data identifying an account database record of a mobile radio apparatus account in an account database stored on an account server,
transaction update means, responsive to data identifying a transaction database record communicated from a retail system, for updating the transaction database record identified by the communicated data to indicate that a payment has been accepted in a payment amount;
means for extracting from the transaction database record identified by the communicated transaction data, the data identifying an account database record in the account database; and
means for communicating the extracted data and the payment amount to the account server.

67. A transaction server according to claim 66, wherein
each transaction database record includes the payment amount, and
the transaction server includes retrieval means, responsive to the data identifying a transaction database record communicated from said retail system, for retrieving said payment amount from the transaction database record identified by the communicated data and communicating the retrieved payment amount to said retail system.

68. A transaction server according to claim 66, including authorisation means, responsive to the data identifying a transaction database record communicated from said retail system, for checking the transaction database record identified by the communicated data and communicating an authorisation to said retail system if a predetermined criterion is met.

69. A method of payment for a product using:
a mobile radio apparatus having a radio communication circuit and a display capable of displaying an image including a graphical representation of data;
a retail system having a reader capable of reading graphically represented data displayed on said display of said mobile radio apparatus; and
a transaction control system remote from said retail system, said retail system and said transaction control system being capable of communicating over a communications link, said transaction control system storing transaction database records of desired transactions each including data identifying a desired product,
the method comprising the steps of:
displaying on said display of said mobile radio apparatus an image including a graphical representation of transaction data which includes data identifying a transaction database record;
using said reader of said retail system to read the graphically represented transaction data displayed on said display of said mobile radio apparatus;
using said retail system to accept a payment;
communicating from said retail system to said transaction control system, the read data identifying a transaction database record and data indicating that payment has been accepted;
updating the transaction database record identified by the communicated data to indicate that payment has been accepted; and
delivering the product identified in the identified transaction database record.

70. A payment system comprising:
a transaction control system storing transaction database records of desired transactions each including data identifying a desired product;
a mobile radio apparatus having a radio communication circuit and a display capable of displaying an image including a graphical representation of transaction data which includes data identifying a transaction database record;
a retail system remote from said transaction control system; and
a communications link between said retail system and said transaction control system,
said retail system comprising:
a reader capable of reading graphically represented transaction data displayed on said display of said mobile radio apparatus;
payment means for accepting a payment; and
means for communicating the read data identifying a transaction database record and data indicating that payment has been accepted over the communications link to said transaction control system;
said transaction control system further comprising means, responsive to the data communicated from said retail system, for updating the transaction database record identified by the communicated data to indicate that payment has been accepted.
